(19) United States
(12) Patent Application Publication
(10) Pub. No.: US 2025/0076491 A1
(43) Pub. Date: Mar. 6, 2025

(54) INFORMATION PROCESSING SYSTEM, INFORMATION PROCESSING METHOD, AND RECORDING MEDIUM

(71) Applicant: NEC Corporation, Minato- ku, Tokyo (JP)

(72) Inventors: Chisato SUGAWARA, Tokyo (JP); Toshimichi YOKOTE, Tokyo (JP); Yosuke KIMURA, Tokyo (JP); Takakazu ISHII, Tokyo (JP); Hiromichi HIRATA, Tokyo (JP); Shouhei OHNO, Tokyo (JP); Nana JUMONJI, Tokyo (JP)

(73) Assignee: NEC Corporation, Minato- ku, Tokyo (JP)

(21) Appl. No.: 18/728,429

(22) PCT Filed: Jan. 25, 2022
(86) PCT No.: PCT/JP2022/002538

§ 371 Date: Jul. 11, 2024

(51) Int. Cl. G01S 13/90; G06T 7/00; G06V 20/10; G06V 20/56

(52) U.S. Cl. CPC G01S 13/9017; G06T 7/0002; G06V 20/182; G06V 20/588; G06T 2207/30252

(57) ABSTRACT

An information processing system, comprising: a memory configured to store instructions; and one or more processors configured to execute the instructions to: acquire a displacement of a structure on a ground; acquire sensor information related to a surface of the structure; determine a surface layer state of the structure based on the sensor information; and output the displacement in an entire or partial region of the structure and the surface layer state in the entire or partial region of the structure.

### TECHNICAL FIELD

The present invention relates to processing of information, and particularly to processing of information related to a structure.

### BACKGROUND ART

PTL 1 discloses an analysis device that divides an observation result of a synthetic aperture radar into a plurality of sections and determines the priority order of the sections using the state values of the sections.

### CITATION LIST

### Patent Literature

PTL 1: WO 2021/084698 A1

### SUMMARY OF INVENTION

### Technical Problem

It is often difficult for those other than experts to understand the observation result of the synthetic aperture radar as it is.

It is an object of the present invention to provide an information processing system and the like that make it easier to process information of a structure on the ground based on an observation result of a synthetic aperture radar and the like.

### Solution to Problem

An information providing system according to an aspect of the present invention includes a displacement acquisition means for acquiring a displacement of a structure on a ground, a sensor information acquisition means for acquiring sensor information related to a surface of the structure, a state determination means for determining a surface layer state of the structure based on the sensor information, and an information output means for outputting the displacement in an entire or partial region of the structure and the surface layer state in the entire or partial region of the structure.

An information providing method according to an aspect of the present invention includes acquiring a displacement of a structure on a ground, acquiring sensor information related to a surface of the structure, determining a surface layer state of the structure based on the sensor information, and outputting the displacement in an entire or partial region of the structure and the surface layer state in the entire or partial region of the structure.

A recording medium according to an aspect of the present invention records a program for causing a computer to execute processing for acquiring a displacement of a structure on a ground, processing for acquiring sensor information related to a surface of the structure, processing for determining a surface layer state of the structure based on the sensor information, and processing for outputting the displacement in an entire or partial region of the structure and the surface layer state in the entire or partial region of the structure.

### Advantageous Effects of Invention

According to the present invention, it is possible to achieve an effect of making it easier to process information of a structure.

### BRIEF DESCRIPTION OF DRAWINGS

FIG. 1 is a block diagram illustrating an example of the configuration of an information processing system according to a first example embodiment.

FIG. 2 is a block diagram illustrating an example of the configuration of an information providing system including an information processing system according to a second example embodiment.

FIG. 3 is a flowchart illustrating an example of an operation of the information processing system according to the second example embodiment.

FIG. 4 is a diagram illustrating an example of display of displacement and deterioration in the second example embodiment.

FIG. 5 is a diagram illustrating an example of display of displacement and deterioration in another row.

FIG. 6 is a diagram illustrating an example of display of displacement and deterioration in a column.

FIG. 7 is a diagram illustrating an example of display of displacement and deterioration in a curved region.

FIG. 8 is a diagram illustrating an example of display of displacement and deterioration of sections.

FIG. 9 is a block diagram illustrating an example of the configuration of an information providing system including an information processing system according to a third example embodiment.

FIG. 10 is a diagram illustrating an example of display of displacement in a row at a plurality of times.

FIG. 11 is a view illustrating an example of display of displacement in another row at a plurality of times.

FIG. 12 is a diagram illustrating an example of display of displacement in a column at a plurality of times.

FIG. 13 is a diagram illustrating an example of display of displacement and deterioration in a row at a plurality of times.

FIG. 14 is a diagram illustrating an example of display of current displacement and deterioration.

FIG. 15 is a diagram illustrating an example of display of displacement and deterioration one year ago.

FIG. 16 is a diagram illustrating an example of display of displacement and deterioration two years ago.

FIG. 17 is a diagram illustrating an example of display of displacement and deterioration three years ago.

FIG. 18 is a diagram illustrating an example of display of displacement exceeding a threshold value at a plurality of times.

FIG. 19 is a flowchart illustrating an example of an operation of the information processing system according to the third example embodiment.

FIG. 20 is a block diagram illustrating an example of the hardware configuration of a computer device forming an information processing system.

FIG. 21 is a conceptual diagram illustrating a specific example of an information providing system.

### EXAMPLE EMBODIMENT

Next, example embodiments of the present invention will be described with reference to the drawings. However, each example embodiment of the present invention is not limited to the description of each drawing. The example embodiments can be appropriately combined.

### First Example Embodiment

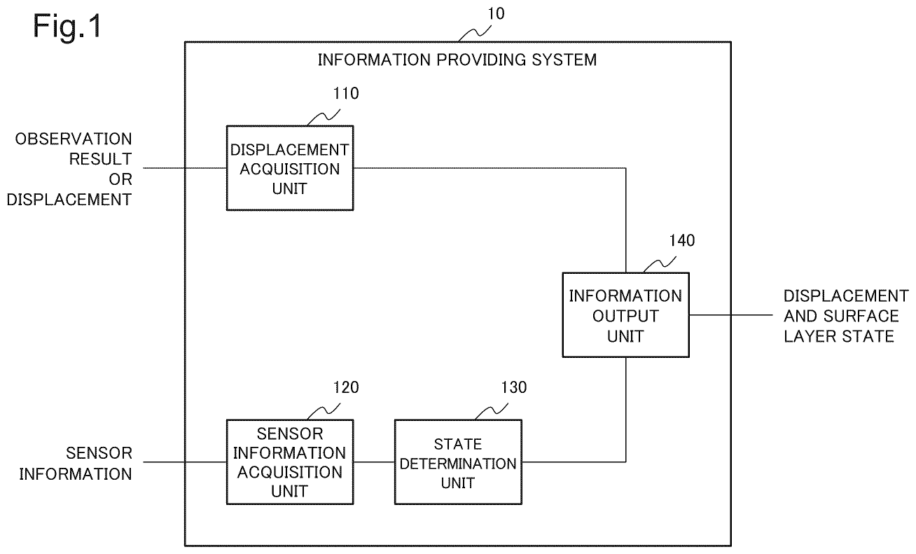

A first example embodiment of the present invention will be described with reference to the drawings. FIG. 1 is a block diagram illustrating an example of the configuration of an information processing system 10 according to a first example embodiment. The information processing system 10 includes a displacement acquisition unit 110, a sensor information acquisition unit 120, a state determination unit 130, and an information output unit 140. The displacement acquisition unit 110 acquires a displacement of a structure on the ground. The sensor information acquisition unit 120 acquires sensor information related to the surface of the structure. The state determination unit 130 determines the surface layer state of the structure based on the sensor information. The information output unit 140 outputs a displacement in the entire or partial region of the structure and a surface layer state in the entire or partial region of the structure. Hereinafter, each configuration will be described in more detail. However, the following description does not limit the first example embodiment.

The displacement acquisition unit 110 acquires a displacement of a structure on the ground. The structure is, for example, a road, a bridge, a slope frame, an embankment, a pier, a bank, or a runway. The structure may include a plurality of structures such as roads and bridges. However, the structure is not limited thereto. For example, the displacement acquisition unit 110 acquires the displacement of the structure by analyzing the observation result of the ground observation system. The ground observation system is, for example, a system including an observation device to observe the ground such as a synthetic aperture radar (SAR). The ground observation system will be further described later. Alternatively, the displacement acquisition unit 110 may acquire the displacement of the structure from the ground observation system. In the following description, these will be collectively described as “displacement acquisition unit 110 acquires a displacement of a structure on the ground”.

The sensor information acquisition unit 120 acquires sensor information related to the surface of the structure. For example, the sensor information acquisition unit 120 acquires, as sensor information, a surface image of a road captured by a dashboard camera (dashcam) mounted on the vehicle or acceleration measured by an accelerometer mounted on the vehicle. However, the sensor information is not limited to the above. Hereinafter, devices that acquire sensor information, such as a dashcam, will be collectively referred to as a “sensor information acquisition device”. The sensor information acquisition device and the sensor information will be further described later.

The state determination unit 130 determines the surface layer state of the structure based on the sensor information. Specifically, the state determination unit 130 determines a deterioration state of the surface layer. The “surface layer” of the structure is a range in which the state can be checked from the surface of the structure. For example, the surface layer is a portion including a surface and a range from the surface to a predetermined depth. For example, when the structure includes a plurality of layers, the surface layer is a layer of the surface of the structure or a predetermined layer including the layer of the surface. For example, when the structure is an asphalt-paved road, the surface layer is a layer of asphalt. In the following description, a portion excluding the surface layer of the structure is referred to as a “deep layer”. For example, when the structure is an asphalt-paved road, the deep layer is a crushed stone layer, a road floor, and a road body. However, the surface layer and the deep layer are not limited to the above. For example, when the structure is an asphalt-paved road, the surface layer may be an asphalt layer and a crushed stone layer.

The information output unit 140 outputs a displacement in the entire or partial region of the structure and a surface layer state in the entire or partial region of the structure. For example, the information output unit 140 outputs a displacement in the entire or partial region of the structure and a surface layer state in the entire or partial region of the structure to another display device (not illustrated) such as a terminal device including a liquid crystal display. The relationship between the information processing system 10 and the display device is not particularly limited.

The displacement of the structure acquired from the ground observation system may be difficult to understand as it is. However, the information output unit 140 outputs a displacement in the entire or partial region of the structure and the surface layer state in the entire or partial structure. Therefore, the user of the information processing system 10 can determine the state or the like in the entire or partial region of the structure using the surface layer state in addition to the displacement. For example, the user of the information processing system 10 can estimate that a region having more deterioration of the surface layer is a region having a higher necessity of repair among regions having the same degree of displacement of the ground. As described above, since the displacement in the entire or partial region of the structure and the surface layer state in the entire or partial region of the structure are output, the information processing system 10 can more easily process the information of the structure.

The information output unit 140 may output a displacement and a surface layer state in a linear region as the displacement and the surface layer state of the partial region of the structure. For example, the information output unit 140 may output a displacement and a surface layer state of a linear region including a line having the entire length or the entire width of the structure, such as the center line of the structure. Alternatively, the information output unit 140 may output a displacement and a surface layer state of a linear region along a predetermined line, such as a lane of a road interposed between lane boundary lines. Alternatively, in the case of a runway, a linear region with which tires are in contact at the time of take-off and landing of an airplane is a region that requires more intensive monitoring than a peripheral region. Therefore, the information output unit 140 may output a displacement and a surface layer state of a linear region including a predetermined line, such as a line with which tires are in contact, as a partial region of the structure. As described above, the information output unit 140 may output a displacement and a surface layer state in a linear region along a predetermined line or a linear region including a predetermined line as a partial region of the structure. As a result, the user of the information processing system 10 can more appropriately perform work on a structure, such as repair, based on the displacement and the surface layer state of an important partial region in the structure such as a region requiring intensive monitoring.

In the following description, in order to avoid complication of the description, the “linear region along the line” and the “linear region including the line” may be collectively referred to as a “linear region”. For example, hereinafter, “displacement of a linear region including a line” and “displacement of a linear region along a line” may be collectively referred to as “displacement of a linear region”. In the following description, the line may be a line actually provided in a structure such as a center line of a road, or may be a virtual line such as a line with which tires on the runway are in contact.

The information output unit 140 is not limited to outputting the displacement and the surface layer state of the linear region. The information output unit 140 may output a displacement and a surface layer state of a curved region such as a lane on a road including a curve, or may output a displacement and a surface layer state of a three-dimensional linear region such as a slope of a ramp of a three-dimensional intersection. As described above, the information processing system 10 may output the displacement and the surface layer state of the predetermined linear region as a partial region of the structure in order to process the information of the structure more easily.

### Second Example Embodiment

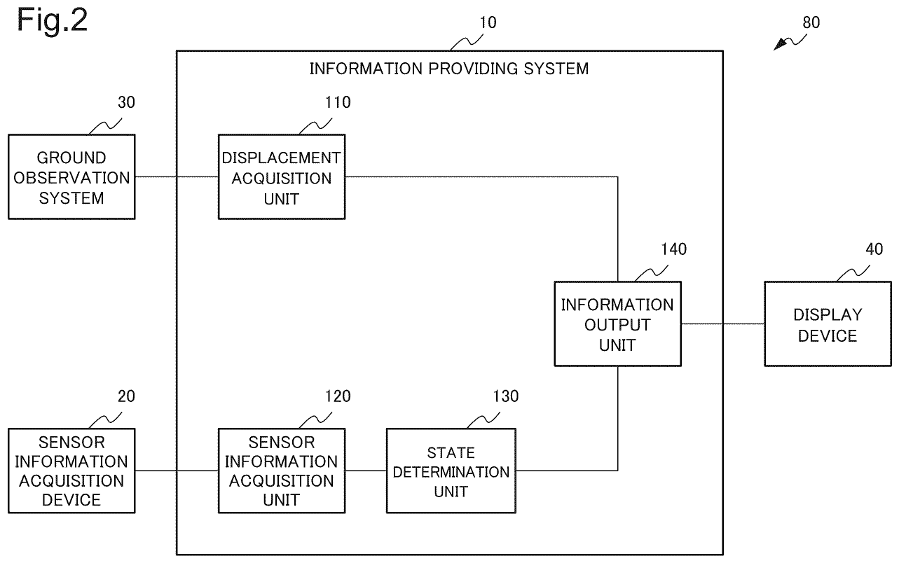

An information processing system 10 according to a second example embodiment will be described with reference to the drawings. FIG. 2 is a block diagram illustrating an example of the configuration of an information providing system 80 including the information processing system 10 according to the second example embodiment. The information providing system 80 includes the information processing system 10, a sensor information acquisition device 20, a ground observation system 30, and a display device 40. The number of components in FIG. 2 is an example, and is not limited to the number illustrated in FIG. 2. For example, the information providing system 80 may include a plurality of sensor information acquisition devices 20.

### (1) Sensor Information Acquisition Device 20

The sensor information acquisition device 20 includes a predetermined sensor, and acquires sensor information related to the surface of the structure using the sensor. For example, the sensor information acquisition device 20 is mounted on or towed by a moving object moving on the upper surface or in the vicinity of the structure, and acquires sensor information related to the surface of the structure. For example, the sensor information acquisition device 20 is a dashcam that is mounted on a vehicle, which is an example of a moving object, and acquires an image of a road, which is an example of sensor information. Alternatively, the sensor information acquisition device 20 may be a vibratory meter that measures vibration of the vehicle or an accelerometer that measures acceleration in vibration of the vehicle. However, the sensor information acquisition device 20 is not limited to the dashcam, the vibratory meter, and the accelerometer mounted on the vehicle. For example, the sensor information acquisition device 20 may be a fixed device such as a fixed camera installed on a road or beside the road. The sensor information acquisition device 20 may be a device capable of changing performance related to acquisition of sensor information such as an imaging direction and a focal length.

The surface of the structure is not limited to a road surface through which a vehicle or the like passes, and may be any surface in contact with the outside, such as a side wall and an upper surface in a tunnel, and is not particularly limited. The moving object on which the sensor information acquisition device 20 is mounted is not limited to a vehicle. For example, an unmanned aerial vehicle (drone) may move with the sensor information acquisition device 20 mounted thereon. Alternatively, like a wearable dashcam, a person may carry the sensor information acquisition device 20.

The sensor information acquired by the sensor information acquisition device 20 is information related to the surface of the structure. For example, the sensor information is an image of a surface of a structure such as an image of a road surface of a road. However, the sensor information is not limited to the image. For example, the sensor information may be magnitude, speed, or acceleration of vibration generated due to unevenness of the road surface. Alternatively, the sensor information may be three-dimensional data such as data acquired using a radio detecting and ranging (RADAR) or a light detection and ranging (LiDAR). The sensor information may include not one piece of information but a plurality of pieces of information such as a combination of an image and acceleration.

As a specific example of the correspondence among the sensor information acquisition device 20, the sensor, and the sensor information, a case where the sensor information acquisition device 20 is a dashcam mounted on a vehicle will be described. In this case, the sensor is a camera of the dashcam. The sensor information is an image captured by the camera. In the following description, as an example, a dashcam is used as the sensor information acquisition device 20, a camera is used as the sensor, and an image of a surface of a structure is used as an example of the sensor information. A vehicle is used as an example of the moving object.

The sensor information may include other information. Hereinafter, an example of information included in the sensor information will be described.

### Identification Information

Information for identifying the sensor information may be included in the sensor information. For example, an identifier may be included in the sensor information. Alternatively, the location where the sensor information is acquired may be included in the sensor information. The location may be a two-dimensional location such as latitude and longitude, or may be a three-dimensional location including height. Alternatively, the time at which the sensor information is acquired may be included in the sensor information. For example, the information processing system 10 may identify the sensor information by using the location and the time included in the sensor information.

### Acquisition Device Information

Information related to the sensor information acquisition device 20 may be included in the sensor information. For example, the information related to the sensor information acquisition device 20 may include at least one of a device name, a model name, an attachment location, and an imaging direction of the sensor information acquisition device 20. Alternatively, information related to the sensor of the sensor information acquisition device 20 may be included in the sensor information. For example, the information related to the sensor may include at least one of the type, specification, and performance of the sensor. For example, when the sensor is a camera, the information related to the sensor may include at least one of a focal length, an aperture, a diaphragm, a shutter speed, and the number of pixels of the camera.

### Moving Object Information

When the sensor information acquisition device 20 is mounted on a moving object, information related to the moving object on which the sensor information acquisition device 20 is mounted may be included in the sensor information. For example, the information related to the moving object may include at least one of a name, a model number, and a type of the moving object. Alternatively, information related to the operation of the moving object may be included in the sensor information. For example, when the moving object is a vehicle, the information related to the operation of the moving object may include information of at least one operation of an accelerator pedal, a brake pedal, a shift lever, a steering wheel, a wiper, a blinker, and opening and closing of a door.

Information about Surroundings

Information about the surroundings when the sensor information is acquired may be included in the sensor information. The information about the surroundings may include, for example, at least one of surrounding weather, temperature, humidity, illuminance, degree of congestion, and sound.

### Worker Information

Information related to the worker in charge of acquiring the sensor information may be included in the sensor information. For example, the information related to the worker may include at least one of a name or an identifier of the worker. Alternatively, information added by the worker may be included in the sensor information. For example, the information added by the worker may be a comment of the worker related to at least one of the structures and the sensor information.

### (2) Ground Observation System 30

The ground observation system 30 observes a ground including a structure using an observation device and outputs an observation result. For example, the ground observation system 30 includes a SAR for observing the ground including a structure, and outputs an image of the ground as an observation result. The observation device in the ground observation system 30 is, for example, a SAR mounted on an artificial satellite, an aircraft, or an unmanned aerial vehicle (drone). However, the observation device is not limited to the SAR, and may be, for example, an optical sensor or a laser measuring device. The ground observation system 30 may output an observation result using a plurality of frequencies (multispectral) instead of one frequency. The ground observation system 30 may analyze the observation result and output the displacement of the ground.

### (3) Information Processing System 10

### (3-1) Displacement Acquisition Unit 110

The displacement acquisition unit 110 acquires a displacement of a structure on the ground. For example, the displacement acquisition unit 110 acquires the displacement of the structure on the ground based on the observation result of the ground observation system 30 including the SAR that observes the ground including the structure. For example, the displacement acquisition unit 110 acquires an observation result from the ground observation system 30. Then, the displacement acquisition unit 110 acquires the displacement of the structure by analyzing the observation result. For example, the displacement acquisition unit 110 acquires the displacement of the ground between two different times from the analysis using the images of the ground at the two different times. The displacement acquisition unit 110 may acquire the time of the observation.

When the ground observation system 30 outputs the displacement of the ground as a result of analyzing the observation result, the displacement acquisition unit 110 may acquire the displacement of the ground from the ground observation system 30. As described in the first example embodiment, as described above, the displacement acquisition unit 110 may acquire the displacement by analyzing the observation result acquired from the ground observation system 30, or may acquire the displacement from the ground observation system 30. Therefore, in the following description, these will be collectively described as “displacement acquisition unit 110 acquires the displacement of the structure on the ground from the ground observation system 30”.

The displacement acquisition unit 110 may perform, as an analysis using the observation result, not only the analysis of the displacement of the ground but also an analysis of a change in intensity of the ground, a factor of the displacement of the ground, the magnitude of a risk based on the displacement of the ground, a difference from prediction based on past displacement of the ground, or the like. When the analysis of a change in intensity of the ground or the like is performed, in the following description, the information processing system 10 may use a change in intensity of the ground or the like instead of the displacement of the ground. For example, the information processing system 10 may output a change in intensity of the ground in the entire or partial region of the structure and a surface layer state in the entire or partial region of the structure. Also, when a change in the intensity of the ground or the like is acquired instead of the displacement of the ground, the displacement acquisition unit 110 may acquire the change in the intensity of the ground or the like from the ground observation system 30. Methods for analyzing images of the ground include change extraction, time-series interference analysis, coherent change extraction, and the like. Alternatively, as a method of analyzing an image of the ground, there is a method of analyzing the displacement of the ground by applying a newly acquired image of the ground to an analysis model generated by machine learning using a past image of the ground and a displacement of the ground.

When an observation result using multispectra is acquired as an observation result, the displacement acquisition unit 110 may analyze the type of the ground in addition to the displacement of the ground as an analysis of the observation result. The type of the ground that can be analyzed is determined according to the frequency to be used. For example, the type of the ground includes at least one of a water surface, mud, garbage, dry soil, grassland, forest, farmland, and snow cover. Also in this case, the displacement acquisition unit 110 may acquire the type of the ground from the ground observation system 30. However, in the following description, as an example of analysis of observation results, it is assumed that the displacement acquisition unit 110 acquires the displacement of the ground.

When the structure is larger than the spatial resolution of the displacement, displacements of a plurality of locations are displacements relevant to the structure. Therefore, when the structure is larger than the spatial resolution of the displacement, the displacement acquisition unit 110 may acquire the displacements of the plurality of locations relevant to the structure in such a way as to cover the structure. The spatial resolution is the minimum distance at which two objects at a close distance can be distinguished as two objects. For example, the spatial resolution of the displacement is the minimum distance of the two displacements. When acquiring the displacement, the displacement acquisition unit 110 may output the location of the structure to the ground observation system 30 and acquire the displacement corresponding to the output location. Alternatively, the displacement acquisition unit 110 may extract the displacement of the location of the structure from the displacement in a predetermined range including the structure acquired from the ground observation system 30. The displacement acquisition unit 110 may acquire a displacement stored in a storage device (not illustrated). The displacement acquisition unit 110 may acquire a speed of displacement that is a rate of change in displacement during a predetermined period or an acceleration that is a rate of change in speed of displacement.

### (3-2) Sensor Information Acquisition Unit 120

The sensor information acquisition unit 120 acquires sensor information related to the surface of the structure. For example, the sensor information acquisition unit 120 acquires sensor information related to the surface of the structure from the sensor information acquisition device 20 mounted on the moving object.

When the structure is larger than the acquisition unit of the sensor information, the sensor information at a plurality of locations is the sensor information relevant to the structure. Therefore, when the structure is larger than the acquisition unit of the sensor information, the sensor information acquisition unit 120 may acquire the sensor information of a plurality of locations relevant to the structure in such a way as to cover the structure. Alternatively, when the information providing system 80 includes a plurality of sensor information acquisition devices 20, the sensor information acquisition unit 120 may acquire the sensor information from the plurality of sensor information acquisition devices 20. In this case, in at least some pieces of sensor information acquired from the plurality of sensor information acquisition devices 20, detection ranges may overlap each other. Alternatively, when acquiring a plurality of pieces of sensor information, the sensor information acquisition unit 120 may acquire sensor information stored in a storage device (not illustrated) as at least a part of the sensor information. The sensor information acquisition unit 120 may output the location of the structure to the sensor information acquisition device 20 and acquire sensor information relevant to the output location. Alternatively, the sensor information acquisition unit 120 may acquire sensor information in a predetermined range including a structure and extract sensor information relevant to the location of the structure from the acquired sensor information.

### (3-3) State Determination Unit 130

The state determination unit 130 determines the surface layer state of the structure based on the sensor information. For example, the state determination unit 130 determines the deterioration state of the surface layer of the structure based on the sensor information. As a determination method, the state determination unit 130 may use, for example, a determination model generated by machine learning using sensor information acquired in the past and correct answer data of the surface layer state. Alternatively, when the sensor information is an image, the state determination unit 130 may determine the surface layer state of the road using predetermined image processing. The state determination unit 130 may determine the surface layer state at a plurality of locations for one piece of sensor information. The state determination unit 130 may determine a plurality of types of surface layer states.

As an example of the surface layer state determined by the state determination unit 130, an example of a case where deterioration related to a road is determined will be described. For example, the state determination unit 130 may determine at least one of a crack, a rut, a pothole, deterioration of a seal on a road surface, and fraying of a peripheral portion of the seal as deterioration of the road. The state determination unit 130 may determine the type of the surface layer state. For example, the state determination unit 130 may determine the type of deterioration such as vertical, horizontal, or alligator cracking in a crack. Alternatively, the state determination unit 130 may determine deterioration of an object provided on a surface of a road such as blur of a white line of a road surface and a road surface sign or damage of a sign. Alternatively, the state determination unit 130 may determine a change in the surface such as wear of the surface layer instead of breakage such as a crack. Alternatively, the state determination unit 130 may determine the state of a processed portion of the road surface such as a straight groove for drainage on the road surface or a circular groove for slip prevention on a slope.

The state determination unit 130 may represent the determination result of the surface layer state using a “deterioration degree” which is the degree of deterioration. The deterioration degree of the road surface used by the state determination unit 130 may be a generally used deterioration degree or a deterioration degree set by the user. The state determination unit 130 may use a deterioration speed that is a rate of change in the deterioration degree in a predetermined period or an acceleration that is a rate of change in the deterioration speed. General degrees of deterioration on roads, runways, and the like include the following.

Crack rate: Value obtained by dividing the area of a crack by the area of a section to be examined.

Rutting amount: Height from a rutting portion to a protrusion in a predetermined range. As the predetermined range, 20 m is often used.

International Roughness Index (IRI): Evaluation index for unevenness of a paved road proposed by the World Bank in 1986.

Boeing Bump Index (BBI): a flatness index adopted by the Federal Aviation Administration in 2009.

### (3-4) Information Output Unit 140

The information output unit 140 outputs a displacement in the entire or partial region of the structure and a surface layer state in the entire or partial region of the structure. For example, the information output unit 140 may output the displacement of the entire structure and the surface layer state of the entire structure. Alternatively, the information output unit 140 may output the displacement of a partial region of the structure and the surface layer state of the entire structure. Alternatively, the information output unit 140 may output the displacement of the entire structure and the surface layer state in a partial region of the structure. Alternatively, the information output unit 140 may output the displacement of a partial region of the structure and a surface layer state of the partial region of the structure. As described above, the information output unit 140 may output the displacement and the surface layer state in the same region, or may output the displacement and the surface layer state in different partial regions.

For example, when the sensor information acquisition device 20 is a dashcam mounted on a vehicle, the sensor information acquisition device 20 acquires sensor information in a road region. Therefore, in this case, the sensor information acquisition unit 120 acquires sensor information of a road region. As a result, the region in the surface layer state determined by the state determination unit 130 is a road region. On the other hand, when the ground observation system 30 uses a SAR mounted on an artificial satellite, the ground observation system 30 can acquire an observation result also in a region other than the road. In this case, the displacement acquisition unit 110 can acquire the displacement of the region other than the road in addition to the displacement of the region of the road. As described above, the region where the displacement can be acquired may be different from the region where the sensor information can be acquired. As a result, the displacement region may be at least partially different from the region in the surface layer state.

When the region in the surface layer state is different from the region of the displacement, the information output unit 140 may output the displacement and the surface layer state in the region where both the displacement and the surface layer state have been acquired. For the region where one of the displacement and the surface layer state is acquired, the information output unit 140 may output the acquired displacement or surface layer state, or may output neither. For example, when the displacement acquisition unit 110 acquires a displacement in a predetermined range including a road and the sensor information acquisition unit 120 acquires sensor information of the road, the information output unit 140 may output the displacement and the surface layer state for the road and output the displacement for other regions. Alternatively, in this case, the information output unit 140 may output the displacement and the surface layer state for the road, and may output nothing for other regions.

When outputting the displacement and the surface layer state of the linear region as a partial region, the information output unit 140 may output the displacement of the linear region corresponding to the entire length or the entire width of the structure such as the center line and the surface layer state as the linear region. For example, when the structure is a rectangle, the information output unit 140 may output the displacement and the surface layer state of the linear region connecting the midpoints of the long sides of the rectangle, or may output the displacement and the surface layer state of the linear region connecting the midpoints of the short sides. Alternatively, the information output unit 140 may output the displacement and the surface layer state of the linear region parallel to the long side or the short side without being limited to the midpoints. Alternatively, the information output unit 140 may output the displacement and the surface layer state of the linear region not parallel to the side. For example, the information output unit 140 may output the displacement and the surface layer state of a linear region oblique to a side or a designated linear region. Alternatively, the information output unit 140 may output the displacement and the surface layer state of the linear region related to the use of the structure. For example, when the structure is a road, the information output unit 140 may output a lane displacement and a surface layer state of the road. Alternatively, the information output unit 140 may output the displacements and the surface layer states of a plurality of linear regions instead of one linear region. For example, when the structure is a road including a plurality of lanes, the information output unit 140 may output the displacement and the surface layer state of each lane. Alternatively, when the structure is a road, the information output unit 140 may output the displacements and the surface layer states of a plurality of intersecting linear regions such as a road including an intersection or a branch.

When outputting the displacements and the surface layer states of a plurality of predetermined linear regions, the information output unit 140 may output information based on the displacements and the surface layer states in the plurality of predetermined linear regions. For example, when a range in which a displacement in a predetermined linear region is large is close to a range in which a displacement in an adjacent linear region is large, the displacement in the range may spread in a wide range. Therefore, when a range in which a displacement in a predetermined linear region is large is close to a range in which a displacement in an adjacent linear region is large, the information output unit 140 may output information indicating the range. As described above, the information output unit 140 may output information indicating that at least one of the displacement and the surface layer state of the adjacent linear region satisfies predetermined conditions.

In the case of using a plurality of linear regions, the information output unit 140 may output the displacement and the surface layer state of a linear region satisfying the conditions regarding at least one of the displacement and the surface layer state. For example, the information output unit 140 may output the displacement and the surface layer state of a linear region in which at least a part or all of the displacement exceeds the threshold value. Alternatively, the information output unit 140 may output the displacement and the surface layer state of a linear region in which the number or area of deterioration exceeds the threshold value.

The information output unit 140 may output the entire displacement and surface layer state of the entire or partial region of the structure, or may output a part of at least one of the displacement and the surface layer state. For example, the information output unit 140 may output a displacement larger than a predetermined value as a part of the displacement. Alternatively, the information output unit 140 may output some types of surface layer states such as deterioration in high need of repair.

As an example of the output of a part of the surface layer state, deterioration of a structure will be described. For example, when deterioration of a road includes a crack, a pothole, and a rut, the information output unit 140 may output all of the crack, the pothole, and the rut as deterioration. However, the pothole has a larger influence on passage than cracks and ruts, and is a deterioration that requires a high repair. Therefore, the information output unit 140 may output only the pothole as deterioration.

The information output unit 140 may change at least one of the displacement and the surface layer state to be output corresponding to at least one of the displacement and the surface layer state for each location. For example, significant deterioration may vary depending on the location of the structure. Therefore, the information output unit 140 may change at least one of the displacement and the surface layer state to be output according to deterioration for each location. For example, when the deterioration is a crack or a rut, the information output unit 140 may output both the crack and the rut, or may output either the crack or the rut according to the location. In deterioration of the road, which of a crack and a rut is more required to be repaired may change depending on the location or the type of the road. Typically, cracking increases before the occurrence of the pothole. Therefore, when the deterioration includes a crack and a rut, the information output unit 140 may output the crack. However, for example, in the case of a place where the traveling direction of the vehicle is frequently changed, such as an intersection, there is a higher possibility that a rut affects the operation of the vehicle. Therefore, in the case of a road including an intersection, the information output unit 140 may output a rut.

The spatial resolution of the displacement is often different from the spatial resolution of the surface layer state. The spatial resolution of the surface layer state is the minimum distance between the two surface layer states determined using the sensor information. In this case, the information output unit 140 may output the spatial resolution of either the displacement or the surface layer state in accordance with the spatial resolution of the other.

For example, when the spatial resolution of the displacement is lower than the spatial resolution of the surface layer state, surface layer states at a plurality of locations are included in one displacement range. Therefore, the information output unit 140 may combine surface layer states at a plurality of locations included in the range of displacement so as to match the spatial resolution of the displacement. For example, the information output unit 140 may output a representative surface layer state such as deterioration having the highest repair necessity among surface layer states at a plurality of locations included in the displacement range. Alternatively, the information output unit 140 may output the number of surface layer states relevant to the displacement as the surface layer state.

In addition to the displacement and the surface layer state, the information output unit 140 may output a speed that is a rate of change in a change in at least one of the displacement and the surface layer state, an acceleration that is a rate of change in the speed of change, or a combination of the speed and the acceleration. For example, when the displacement at a predetermined point increases with the elapse of time, the speed of change in displacement is a speed at which the magnitude of displacement changes. Alternatively, for example, when the surface layer state is deteriorated, the speed of the surface layer state is a speed at which the deterioration of the surface layer progresses. For example, when a crack is used as the surface layer state, the speed of change in the surface layer state is an increasing speed of the crack rate or a speed at which the area of the crack expands. The speed of displacement, the speed of the surface layer state, the acceleration of displacement, and the acceleration of the surface layer state can be calculated based on the accumulated data. For example, the information output unit 140 may output the displacement in the entire or partial region of the structure and the change speed of the displacement. Alternatively, the information output unit 140 may output deterioration and a deterioration speed in the entire or partial region of the structure.

The displacement and the surface layer state do not always change steadily. Therefore, the speed and the acceleration may change according to the period to be calculated. Therefore, the information output unit 140 may use a preset period or a period designated by the user as the calculation period of the speed and the acceleration.

The information output unit 140 may output the displacement and the surface layer state in each of the sections obtained by dividing the structure into a plurality of sections. The section can be arbitrarily set, and may be, for example, at least one of a unit of management of a structure, a unit of determination of a state of a structure, a unit of repair of a structure, and a combination thereof.

When at least one of the displacement and the surface layer state is plural in the section, the information output unit 140 may output all the displacements and all the surface layer states. Alternatively, the information output unit 140 may output a part of at least one of the displacement and the surface layer state. For example, the information output unit 140 may output some types of surface layer states among the surface layer states included in the section, such as deterioration in high need of repair. Alternatively, the information output unit 140 may output a displacement larger than a predetermined value among the displacements included in the section. The information output unit 140 may output a value calculated from at least one of a plurality of displacements and surface layer states included in the section, such as an average value of displacements or the number of deteriorations included in the section.

The information output unit 140 may output the displacement and the surface layer state of the designated section. The designation is not limited to designation of a section, and may be, for example, a condition of a section to be output. The condition of the section is, for example, a condition that satisfies at least one of the displacement and the surface layer state. Alternatively, the condition of the section may be a condition that the speed of at least one of the deterioration and the surface layer state is satisfied. Alternatively, the condition of the section may be a condition that the acceleration of at least one of the deterioration and the surface layer state is satisfied.

### (3-5) Information Processing System 10

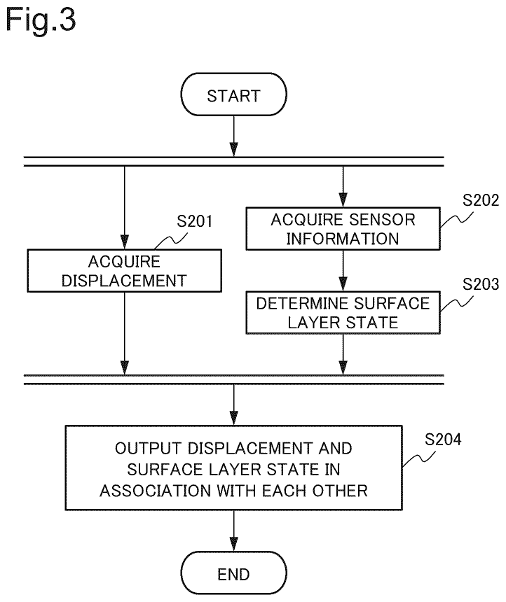

Next, an operation of the information processing system 10 will be described with reference to the drawings. FIG. 3 is a flowchart illustrating an example of the operation of the information processing system 10 according to the second example embodiment. The displacement acquisition unit 110 acquires a displacement of a structure on the ground (step S201). The sensor information acquisition unit 120 acquires sensor information related to the surface of the structure (step S202). The state determination unit 130 determines the surface layer state of the structure based on the sensor information (step S203). The information output unit 140 outputs the displacement in the entire or partial region of the structure and the surface layer state in the entire or partial region of the structure (step S204). Either the operation in step S201 or the operations in steps S202 and S203 may be executed first.

The information processing system 10 may repeat the output of the displacement and the surface layer state every time predetermined conditions are satisfied. For example, the information processing system 10 may output the displacement and the surface layer state according to the timing at which at least one of the displacement and the sensor information is acquired or updated. Alternatively, the information processing system 10 may re-acquire the displacement and the sensor information according to the management cycle of the structure, and repeat the output of the displacement and the surface layer state. Alternatively, the information processing system 10 may re-acquire at least one of the displacement and the sensor information according to a predetermined cycle such as monthly or weekly or an update cycle of at least one of the displacement and the sensor information and output the displacement and the surface layer state. For example, the information processing system 10 may re-acquire the displacement and the sensor information on a predetermined day of every month and output the displacement and the surface layer state.

Alternatively, when an instruction to output the displacement and the surface layer state is acquired from the user, the information processing system 10 may acquire the displacement and the sensor information and output the displacement and the surface layer state. In this case, the information processing system 10 may output the displacement and the surface layer state of the linear region designated by the user instead of the entire structure.

When the operation of outputting the displacement and the surface layer state of the partial region is repeated, the information processing system 10 may change the region whose displacement and surface layer state are output. For example, the information output unit 140 may output the displacement and the surface layer state of the entire structure at a first time and then output the displacement and the surface layer state of the linear region in which at least one of the displacement and the surface layer state satisfies predetermined conditions. For example, the information processing system 10 may output the displacement and the surface layer state of the linear region in which the displacement exceeds the threshold value or becomes a predetermined deterioration state.

The displacement of the structure can be regarded not as deformation of the structure but as displacement including the ground that is the foundation of the structure. Therefore, the displacement of the structure greatly affects the structure. However, the spatial resolution of the displacement is in a wide range to some extent. For example, the spatial resolution of the SAR is often on the order of several meters at the highest.

On the other hand, the spatial resolution of the surface layer state determined using the sensor information acquired from the sensor information acquisition device 20 such as a dashcam is about several centimeters to several tens of centimeters. Therefore, the surface layer state determined by the state determination unit 130 often indicates the state of the surface layer of the structure in more detail than the displacement acquired by the displacement acquisition unit 110. However, the surface layer state may not necessarily be information reflecting the ground state of the structure. For example, the surface layer state may change in association with weather such as rain or snow. In this case, the surface layer state is not a state related to the entire structure, but is an individual state in a part.

Therefore, the information processing system 10 outputs the displacement of the entire or partial region of the structure and the surface layer state of the entire or partial region of the structure. As a result, the information processing system 10 can process the information on the structure in the entire or partial region of the structure more easily than in the case of the displacement alone. As described above, since the information processing system 10 analyzes and outputs the information of the linear region, it is possible to easily check the information of the region of interest. For example, in the case of a road, the user can check detailed information regarding a lane with a large traffic volume based on information of a linear region in a lane with a large traffic volume. In the case of a runway, the user can check detailed information of a linear region that is likely to be in contact with airplane tires frequently.

### (4) Display Device 40

The display device 40 displays the displacement of the entire or partial region of the structure and the surface layer state of the entire or partial region of the structure that are output from the information output unit 140. As long as the display device 40 can display the displacement and the surface layer state, the type of device and the place where the device is placed do not matter. For example, the display device 40 is a display included in a road management system of a local government, but is not limited thereto. The display of the display device 40 in the following description is determined by the information processing system 10. However, the relationship between the information processing system 10 and the display device 40 is not particularly limited. Therefore, in the following description, for convenience of description, there is a case where “the display device 40 changes the display” is described.

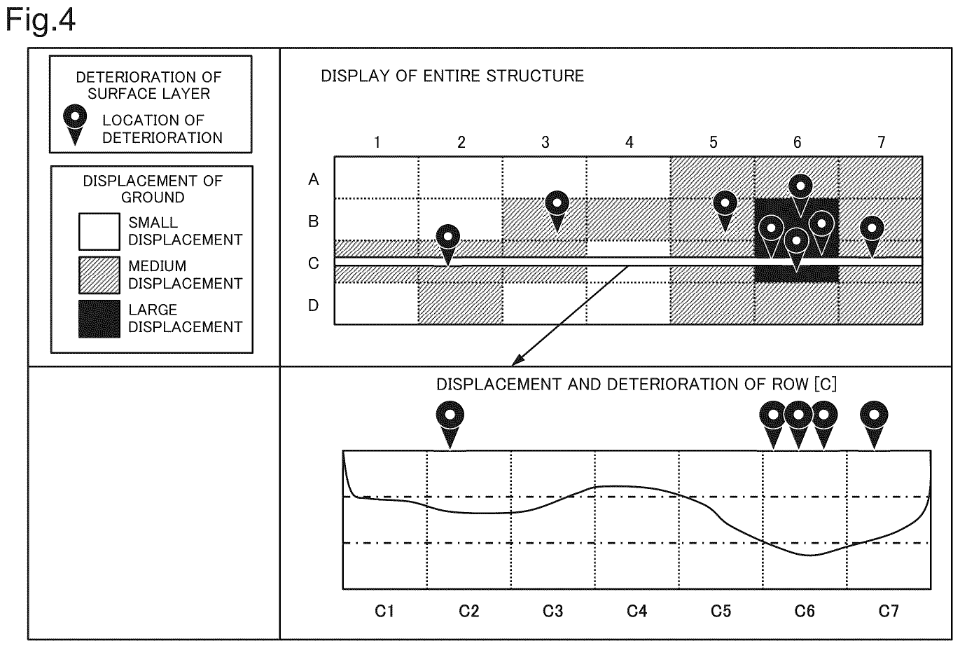

The display of the displacement and the surface layer state on the display device 40 will be described with reference to the drawings. FIG. 4 is a diagram illustrating an example of display of displacement and deterioration in the second example embodiment. In FIG. 4, the display device 40 displays displacement and deterioration of the entire structure on the upper right. In FIG. 4, in order to make it easier to understand the state of the displacement of a structure, sections are used. Specifically, the display device 40 displays, as sections, sections obtained by dividing the structure into seven sections in the horizontal direction and dividing the structure into four sections in the vertical direction. Then, the display device 40 displays a number indicating a column on the structure and displays an alphabet indicating a row on the left of the structure, as an index indicating a section. In the following description, alphabets and numbers are used to designate rows, columns, and sections in a structure. For example, the third row from the top is row [C], the second column from the left is column [2], and the intersection section is section [C2]. Then, the display device 40 classifies the displacement of each section into three types of large, medium, and small, and changes the display of the section according to the magnitude of the displacement. The display device 40 displays the deterioration using an icon at a location where the deterioration that is an example of the surface layer state is determined. The display device 40 may classify the displacement using any scale and display the section corresponding to the classification, not limited to “large, medium, and small”. For example, the display device 40 may classify the displacement in increments of 1 mm and display the section corresponding to the classification.

The display device 40 may display not only the displacement but also the color of the section corresponding to the number, area, or type of surface layer states included in the section. For example, in FIG. 4, the display device 40 may display a color of a section corresponding to the number, area, or type of deterioration instead of the large, medium, and small displacements. The display device 40 may display an icon corresponding to the type of the surface layer state. For example, in FIG. 4, the display device 40 may display an icon at the location of the pothole instead of the deterioration location. Alternatively, in FIG. 4, the display device 40 may display the color of the section corresponding to the speed of at least one of the displacement and the surface layer state instead of the large, medium, and small displacements. Alternatively, the display device 40 may display the color of the section corresponding to the acceleration of at least one of the displacement and the surface layer state instead of the large, medium, and small displacements. As described above, the display device 40 may display the section corresponding to at least one of the displacement and the surface layer state.

The display device 40 displays the displacement and the surface layer state of the white linear region of the row [C], which is an example of the linear region, in the lower part of FIG. 4. FIG. 4 illustrates a case of sinking as an example of displacement. That is, the solid line in the lower part of FIG. 4 indicates the sinking of the white linear region in the upper part of FIG. 4. A one-dot chain line in the lower part of FIG. 4 indicates two threshold values for dividing the displacement into large, medium, and small. A portion where the sinking is lower than the lower one-dot chain line has a large displacement. A portion where the sinking is interposed between two one-dot chain lines is a portion where the displacement is medium. A portion where the sinking is higher than the one-dot chain line is a portion where the displacement is small.

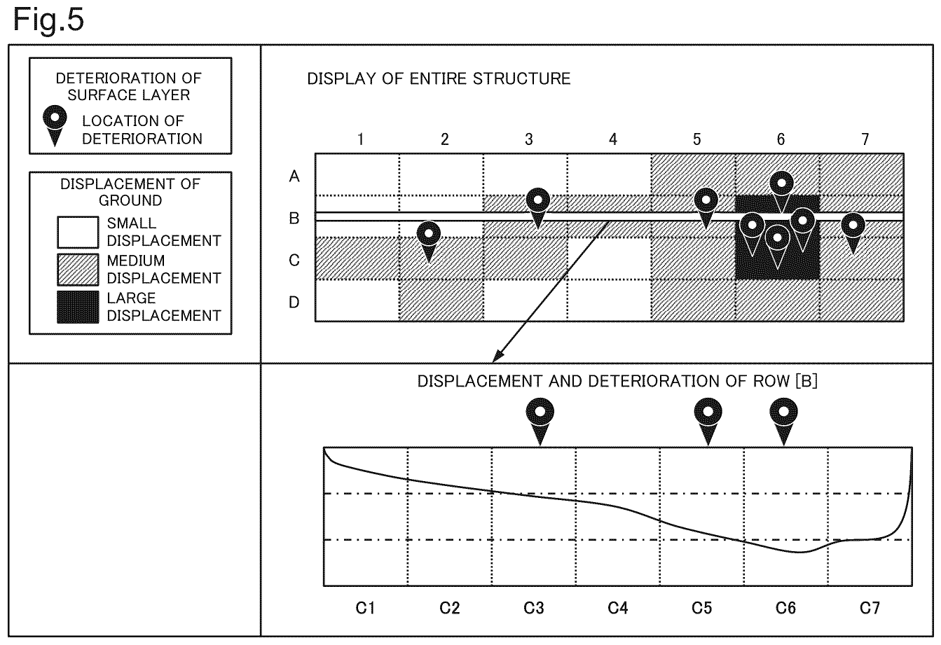

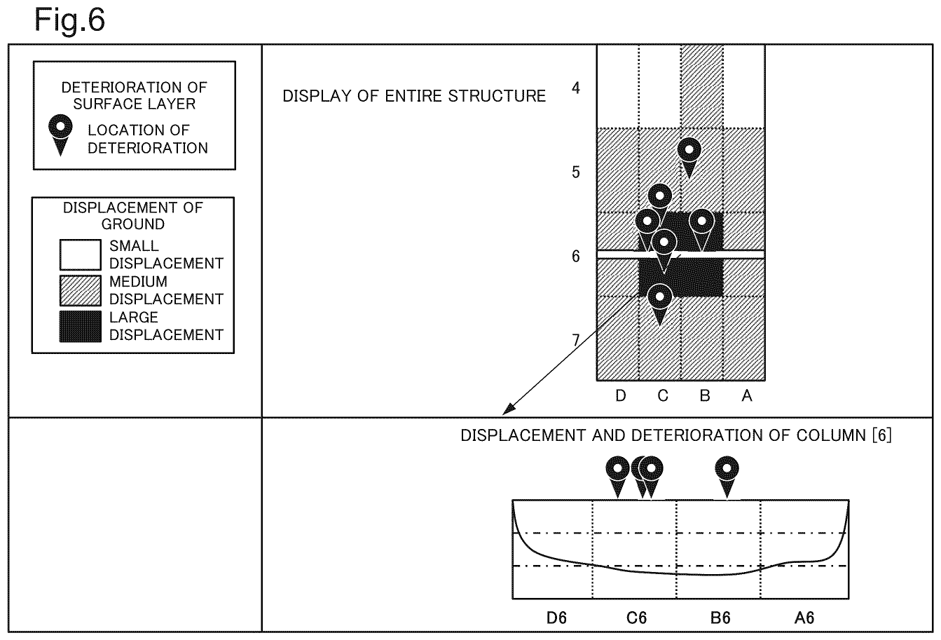

The display device 40 may display a displacement of a region at a location different from that in FIG. 4 as a partial region. FIG. 5 is a diagram illustrating an example of display of displacement and deterioration of row [B] which is another row. Alternatively, the display device 40 may display displacement of a region in a direction different from the regions in FIGS. 4 and 5 as a partial region. Alternatively, the display device 40 may change the display direction of the structure. FIG. 6 is an example of display of displacement and deterioration of a row. In FIG. 6, the display device 40 changes the display of the structure to a display in a direction rotated by 90 degrees from the display direction in FIGS. 4 and 5. Therefore, in FIG. 4, columns [1] to [3] that are part of the structure are out of the display range of display device 40. As described above, the display device 40 may display a partial region of the structure instead of the entire structure. In FIG. 6, the positional relationship between the row and the column is also rotated by 90 degrees. However, in the following description, the horizontal direction is referred to as a column, and the vertical direction is referred to as a row in the description of FIG. 6 in order to maintain a correspondence relationship with other drawings.

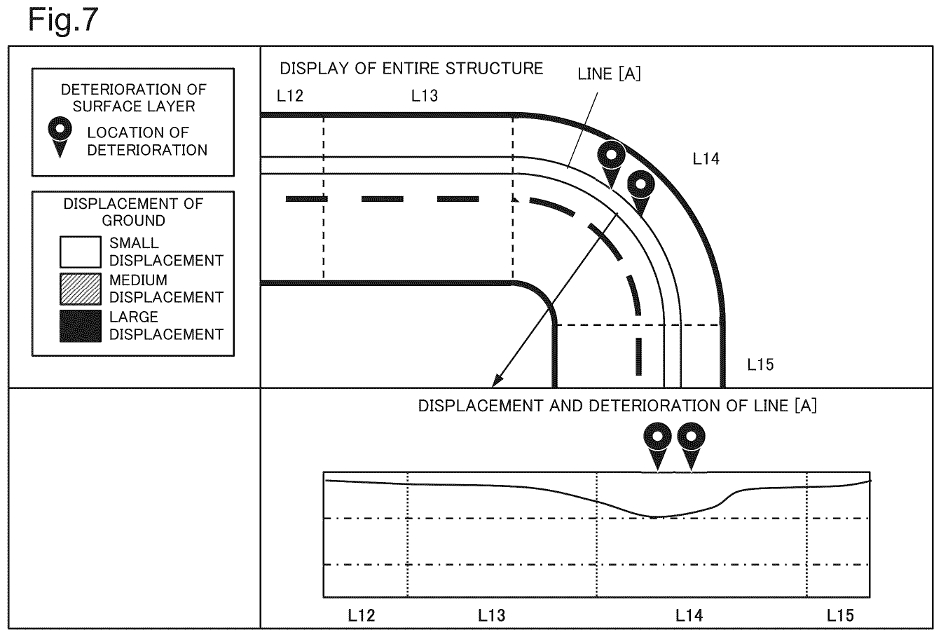

In FIG. 6, the display device 40 displays details of displacement and deterioration in column [6]. In FIG. 6, in order to make the display easily viewable, the display device 40 makes the display of the width of the structure larger than the entire upper view in the display of the displacement in column [6]. As described above, the display device 40 may display the displacement and the surface layer state of the entire structure and the displacement and the surface layer state of the linear region using different scales. When the information processing system 10 outputs the displacement and the surface layer state of the curved region, the display device 40 displays the displacement and the surface layer state of the curved region. FIG. 7 is a diagram illustrating an example of display of displacement and deterioration of a curved region. Specifically, FIG. 7 illustrates displacement and deterioration on a road including a curve as a structure.

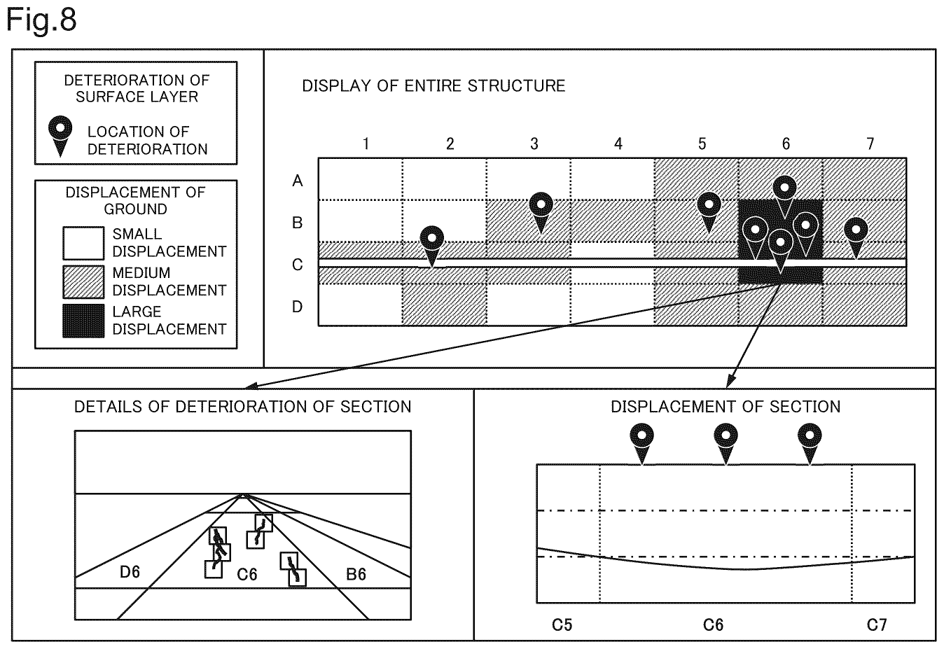

When the information output unit 140 outputs the details of the displacement and the surface layer state in each section, the display device 40 may display the details of the displacement and the surface layer state in the section. For example, the display device 40 may display the displacement and the surface layer state of the designated section. FIG. 8 is a diagram illustrating an example of display of displacement and deterioration of a section. In FIG. 8, the display device 40 displays the displacement and deterioration of section [C6]. The display device 40 displays an image of section [C6] as details of the deterioration of section [C6]. The display device 40 superimposes a square indicating the location of the crack on the image as a reference of the location where the deterioration is detected. The image in FIG. 8 is an image acquired by the dashcam mounted on the vehicle traveling from right to left of the structure in FIG. 8. Therefore, in FIG. 8, the section is a trapezoidal image in a perspective view having a convergence point near the center of the deterioration image. In order to improve the visibility, the display device 40 may deform the shape of the section to be displayed using predetermined image processing. For example, the display device 40 may change the shape of the section of the trapezoid in the perspective view into a rectangle and display the rectangle.

### Third Example Embodiment

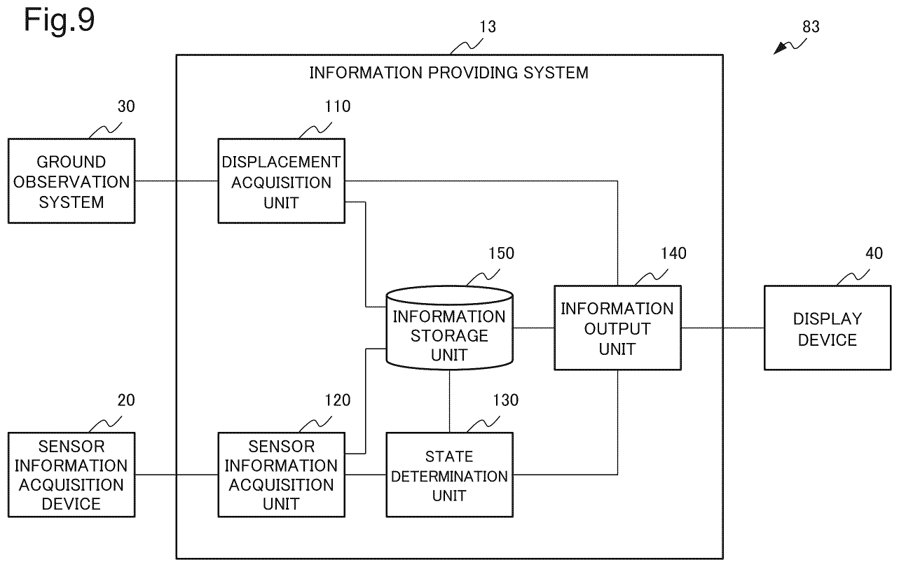

FIG. 9 is a block diagram illustrating an example of the configuration of an information providing system 83 including an information processing system 13 according to a third example embodiment. The information providing system 83 includes an information processing system 13 instead of the information processing system 10 in a configuration similar to that of the information providing system 80 according to the second example embodiment. Therefore, the information processing system 13 will be described below, and description of other configurations will be omitted. The information processing system 13 further includes an information storage unit 150 in addition to the same configuration as the information processing system 10. Therefore, the configuration and operation related to the information storage unit 150 will be mainly described.

In the acquisition of the displacement from the ground observation system 30, the displacement acquisition unit 110 further acquires a time at which the observation device in the ground observation system 30 has observed the ground. The displacement is obtained by analyzing the observation result. Therefore, hereinafter, the time of observation may be referred to as “time of displacement”. When a plurality of observation results are used for the analysis of the displacement, the time of displacement is the last observation time. In the acquisition of the sensor information from the sensor information acquisition device 20, the sensor information acquisition unit 120 further acquires the acquisition time of the sensor information by the sensor information acquisition device 20. In the determination of the surface layer state, the state determination unit 130 outputs the acquisition time of the sensor information used for the determination as the time of the surface layer state. The information storage unit 150 stores at least either displacements at a plurality of times or surface layer states at a plurality of times. Then, the information output unit 140 outputs at least either the displacements or the surface layer states corresponding to a plurality of times in the entire or partial region of the structure.

For example, the information storage unit 150 may store the displacement and the time of displacement in association with each other. Alternatively, the information storage unit 150 may store the surface layer state and the time of the surface layer state in association with each other. The information storage unit 150 may store the sensor information and the time of the sensor information in association with each other. In this case, the information output unit 140 may acquire the surface layer state and the time of the surface layer state determined by the state determination unit 130 based on the sensor information at the target time.

The information output unit 140 outputs at least either displacements at a plurality of designated times and surface layer states at a plurality of designated times. For example, the information output unit 140 may output the displacements at a plurality of times and the surface layer state at a predetermined time. Alternatively, the information output unit 140 may output the surface layer states at a plurality of times and the displacement at a predetermined time. Alternatively, the information output unit 140 may output the displacements at a plurality of times and the surface layer states at a plurality of times. In the above case, the information output unit 140 may output the displacement and the surface layer state at different times in at least some of the displacements and the surface layer states.

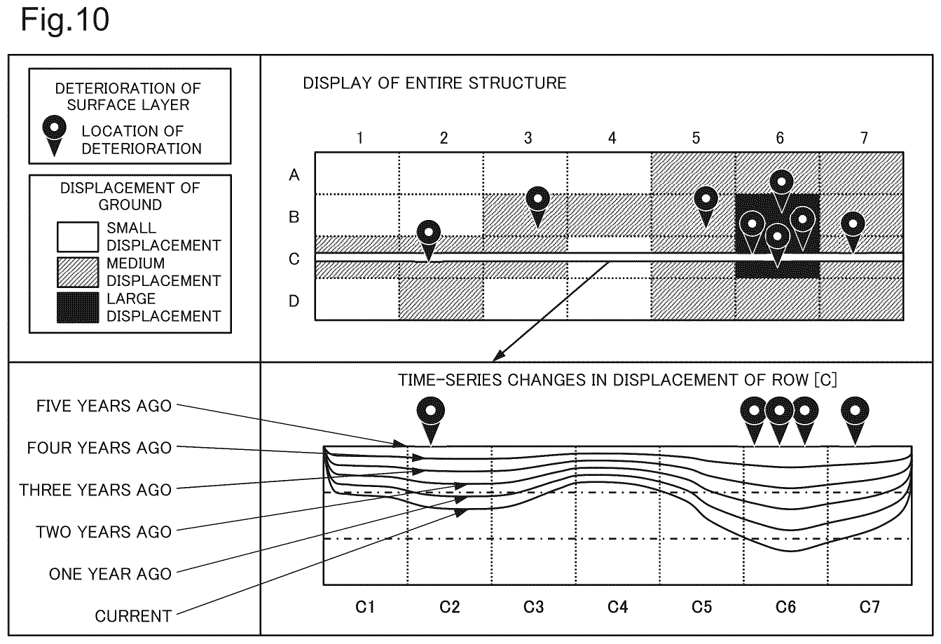

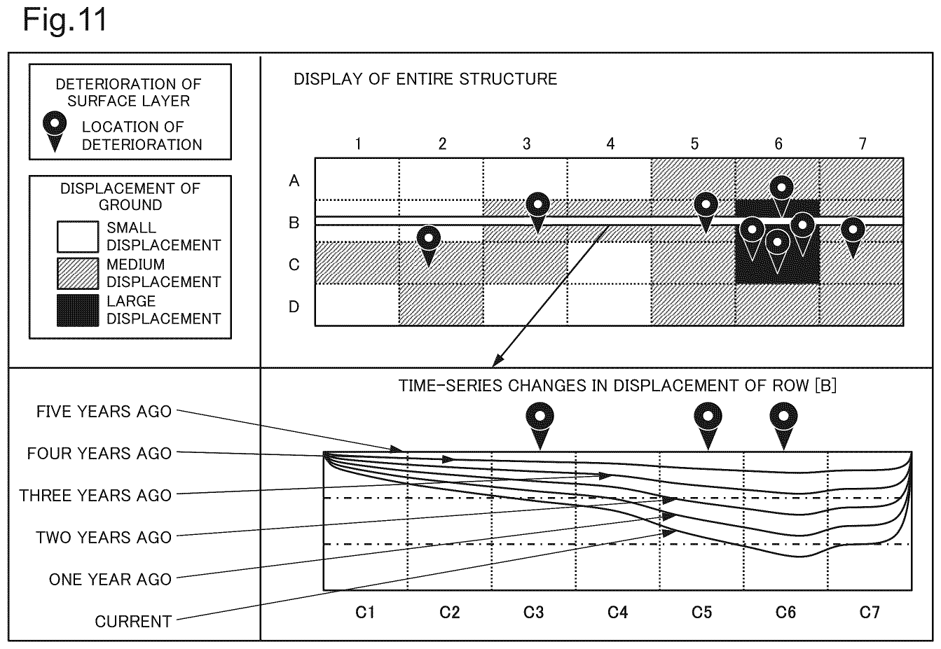

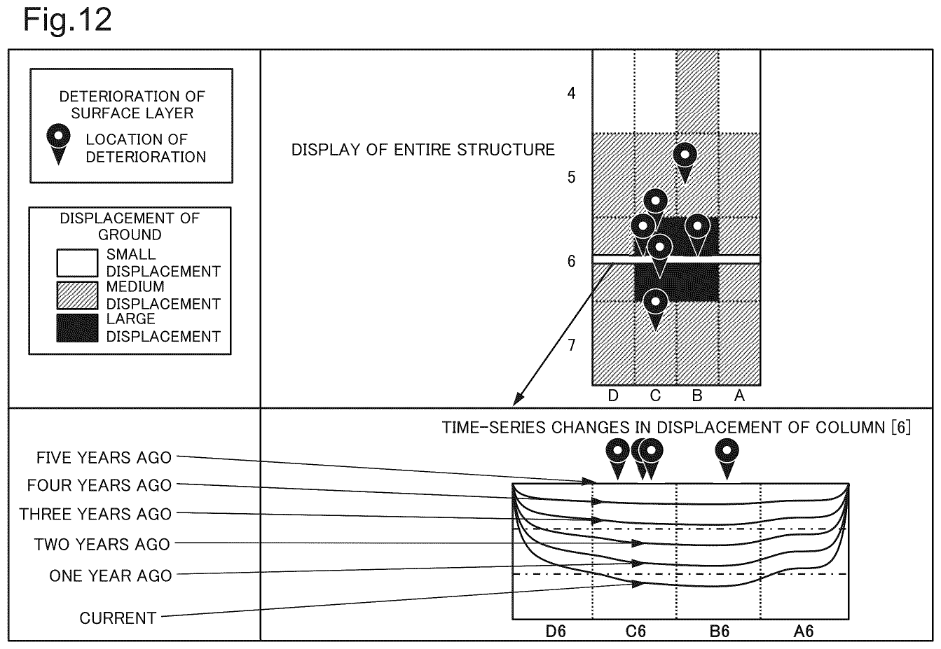

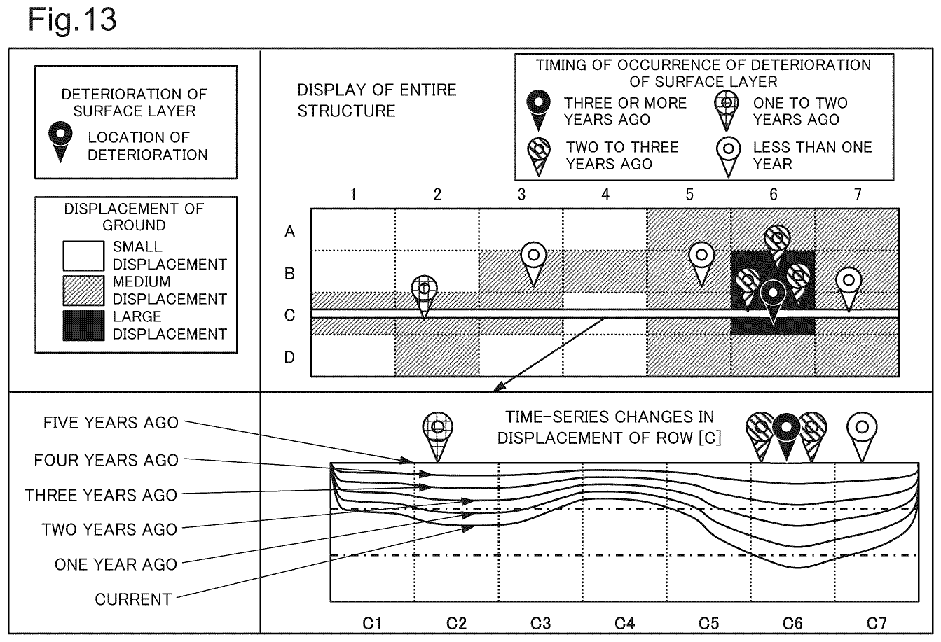

A case where the information output unit 140 outputs a plurality of time displacements will be described with reference to the drawings. FIG. 10 is a diagram illustrating an example of display of the displacement of the row [C] at a plurality of times. In FIG. 10, displacement transition up to the present is chronologically displayed at 1-year intervals based on the ground state five years ago. Due to the difference from the state five years ago, the straight line at the top of the drawing is in a state in which the difference is zero, that is, a state five years ago. FIG. 11 is a diagram illustrating an example of display of the displacement of the row [B] which is another row at a plurality of times. FIG. 12 is a diagram illustrating an example of display of the displacement of the column [6] at a plurality of times. FIG. 13 is a diagram illustrating an example of display of displacement and deterioration of the row [C] at a plurality of times. In FIG. 13, the display of the icon at the deterioration location is changed according to the deterioration occurrence time. Display of icons may be selectable between display and non-display for each type of icons.

The information output unit 140 may output the displacement and the surface layer state corresponding to the designated time. For example, the information output unit 140 acquires the displacement and the surface layer state corresponding to the designated time from the information storage unit 150. Then, the information output unit 140 may output the acquired displacement and surface layer state. For example, the information output unit 140 may output the designated time, the displacement, and the surface layer state to the display device 40. In this case, the display device 40 may display the acquired displacement, surface layer state, and time. When the displacement and the surface layer state are newly acquired after the displacement and the surface layer state are displayed, the display device 40 may display the newly acquired displacement and surface layer state in addition to the displacement and the surface layer state already displayed. Alternatively, the display device 40 may display the newly acquired displacement and surface layer state instead of the displacement and the surface layer state already displayed.

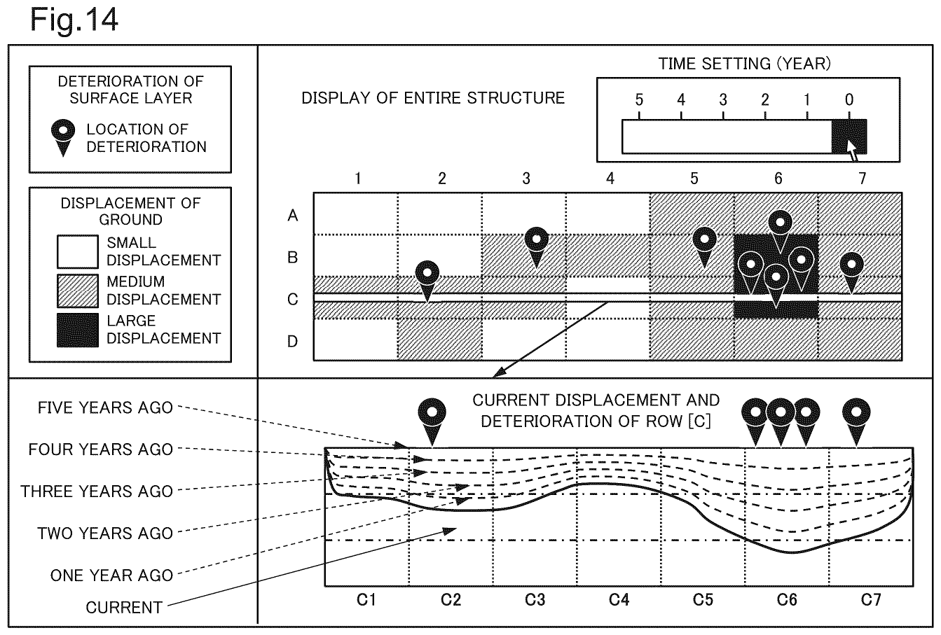

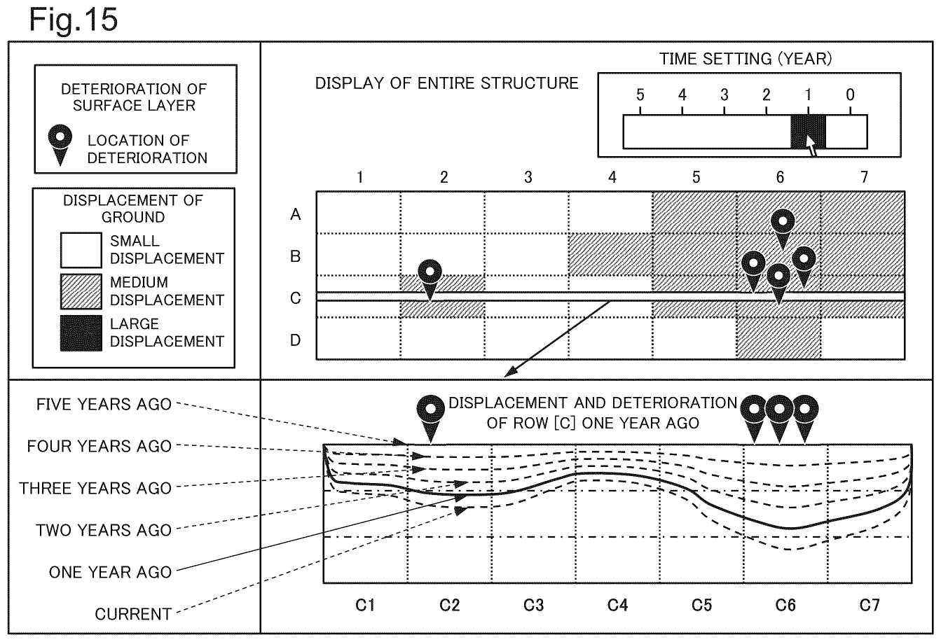

With reference to the drawings, a description will be given using a display of a displacement and a surface layer state corresponding to a designated time. FIG. 14 is a diagram illustrating an example of display of current displacement and deterioration. In FIG. 14, the display device 40 displays the entire displacement and deterioration of the current structure and the displacements at a plurality of times in the row [C]. However, in the displacements at the plurality of times in the row [C], the display device 40 shows the designated year, that is, the current displacement by a solid line and the displacements in other years by a broken line. In FIGS. 15 to 17 described below, similarly, the solid line indicates the displacement in the designated year, and the broken line indicates the displacement in other years. The display device 40 may not display the displacement in a year different from the designated year. In FIG. 14, the display device 40 indicates the designated time using the upper right slide bar. The display device 40 may allow the user to move the knob of the slide bar. In this case, the user may designate the time to be displayed by moving the knob. In FIG. 14, the display unit of time is year. However, the movement of the knob is not limited to the year, and may be continuously moved corresponding to the resolution of the display. That is, in the change of the drawing used in the following description, the display device 40 may continuously change the display. However, the knob may move discontinuously at a predetermined point in time, such as every year.

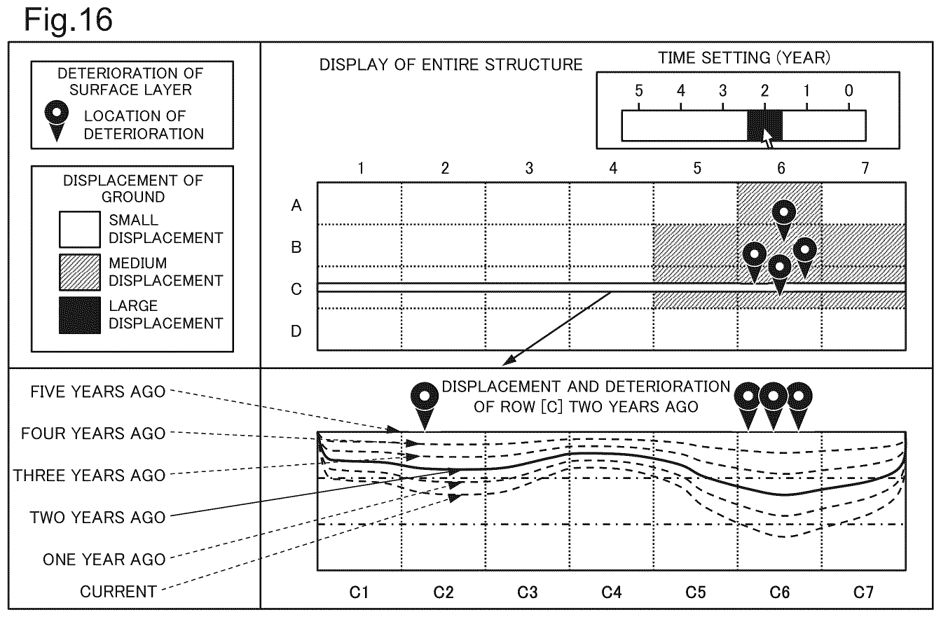

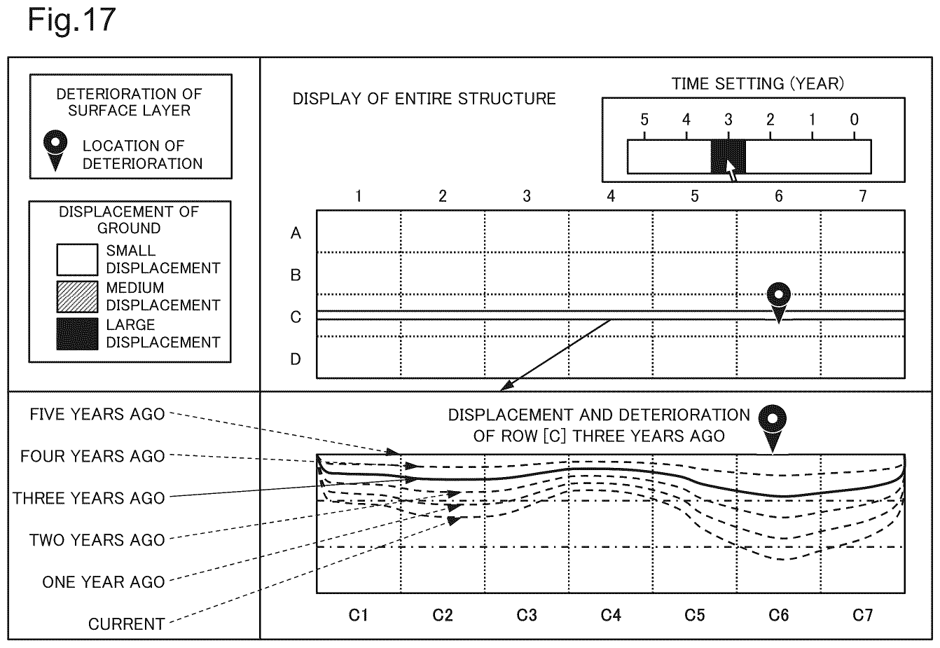

FIG. 15 is a diagram illustrating an example of display of displacement and deterioration one year ago. In FIG. 15, the display device 40 displays the entire displacement and deterioration of the structure one year ago and the displacement at a plurality of times in the row [C]. In the displacement in the row [C] of FIG. 15, the solid line is the displacement one year ago. FIG. 16 is a diagram illustrating an example of display of displacement and deterioration two years ago. FIG. 17 is a diagram illustrating an example of display of displacement and deterioration three years ago. As described above, when the designated time changes, the information output unit 140 may output the displacement and the surface layer state according to the change in time. As a result, as illustrated in FIGS. 14 to 17, the user can grasp the change in the structure with reference to the displacement and the surface layer state at a plurality of times.

For example, underground construction of a structure may affect structures on the ground. Therefore, the user can determine whether there is an influence of construction based on the displacement and the surface layer state before and after the construction. The designation of the time to be displayed is not limited to the slide bar, and a designation method different from the slide bar, such as calendar display, may be used.

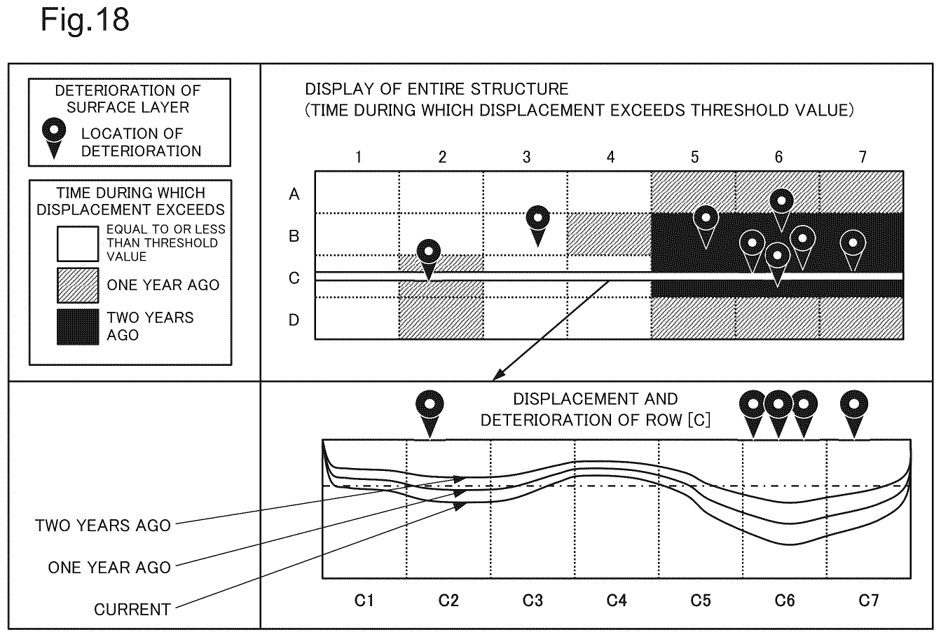

When at least one of the displacement and the surface layer state satisfies predetermined conditions at the designated time, the information output unit 140 may output at least one of the displacement and the surface layer state satisfying the conditions. For example, the information output unit 140 may output a displacement exceeding a threshold value at the designated time and a corresponding surface layer state. Alternatively, the information output unit 140 may output the location of the pothole generated at the designated time and the corresponding displacement. In this case, the display device 40 may display at least one of the displacement and the surface layer state at that time. FIG. 18 is a diagram illustrating an example of display of displacement exceeding a threshold value at each of a plurality of times. In FIG. 18, as the displacement exceeding the threshold value, the display device 40 displays a section where the threshold value was exceeded two years ago, a section where the threshold value was exceeded one year ago, and a section where the threshold was not exceeded. For example, when construction is performed one and a half years ago, the user can determine whether there is an influence of construction based on a section whose displacement exceeds a threshold value two years ago, which is before the construction, and a section whose displacement exceeds a threshold value one year ago, which is after the construction. In this manner, the user can determine the influence of construction or the like even by using the display of FIG. 18. The deterioration in FIG. 18 is current deterioration. However, the display device 40 may display deterioration at different times.

The information output unit 140 may output at least one of the displacement and the surface layer state when the change speed of the displacement at a plurality of times satisfies predetermined conditions. Alternatively, the information output unit 140 may output at least one of the displacement and the surface layer state when the change speed of the surface layer state at a plurality of times satisfies predetermined conditions. Alternatively, the information output unit 140 may output at least one of the displacement and the surface layer state when the acceleration of the change in the displacement at a plurality of times satisfies predetermined conditions. Alternatively, the information output unit 140 may output at least one of the displacement and the surface layer state when the acceleration of the change in the surface layer state at a plurality of times satisfies predetermined conditions. For example, when the change speed of the displacement becomes equal to or greater than the threshold value from the average change speed so far, the information output unit 140 may output the displacement, the corresponding surface layer state, and the time at which the threshold value is exceeded. When outputting at least one of the displacement and the surface layer state satisfying the predetermined conditions, the information output unit 140 may output at least one of the displacement and the surface layer state at least one of the time before and the time after the displacement and the surface layer state at the time when the conditions are satisfied, in addition to the displacement and the surface layer state at the time when the conditions are satisfied. When the section is used, the information output unit 140 may output details of at least one of the displacement and the surface layer state of the section satisfying the conditions.

The information storage unit 150 is not limited to the displacement and the surface layer state, and may store other information related to the structure. For example, the information storage unit 150 may store a repair history of a structure.

In this case, the information output unit 140 may output the displacement and the surface layer state based on the repair history stored in the information storage unit 150. For example, when a plurality of lines are designated as a partial region for outputting the displacement and the surface layer state, the information output unit 140 may determine the number of times of repair in the designated line and output the displacement and the surface layer state of the linear region in which the number of times of repair within a predetermined period exceeds a threshold value. Alternatively, the information output unit 140 may output the displacement and the surface layer state of the linear region in which the displacement has changed more than the threshold value from the previous repair or the number or area of the deteriorated parts has increased more than the threshold value from the previous repair.

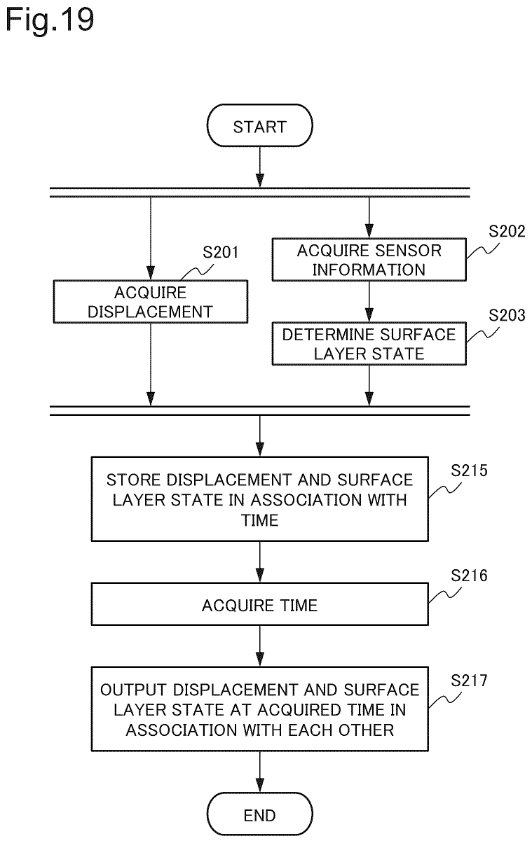

FIG. 19 is a flowchart illustrating an example of the operation of the information processing system 13 according to the third example embodiment. The displacement acquisition unit 110 acquires a displacement of a structure on the ground (step S201). The sensor information acquisition unit 120 acquires sensor information related to the surface of the structure (step S202). The state determination unit 130 determines the surface layer state of the structure based on the sensor information (step S203). The information storage unit 150 stores the displacement, the surface layer state, and the time in association with each other (step S215). Either the operation in step S201 or the operations in steps S202 and S203 may be executed first.

The information output unit 140 acquires the time of the displacement and the surface layer state (step S216). The information output unit 140 may acquire a plurality of times. The information output unit 140 outputs the displacement and the surface layer state corresponding to the acquired time (step S217). When acquiring a plurality of times, the information output unit 140 may output displacements and surface layer states corresponding to the plurality of times. The information processing system 13 may repeat the operations of steps S216 and S217.

The observation time as the basis for displacement analysis may not match the acquisition time of the sensor information that is the basis for determining the surface layer state. That is, the time of the displacement may not match the time of the surface layer state. The observation time and the acquisition time of the sensor information do not necessarily match each other in the entire structure, and may be different at least at some locations. In such a case, the information output unit 140 outputs the corresponding displacement and surface layer state from among the displacements and surface layer states at different times.

For example, it is assumed that the information storage unit 150 stores weekly displacements and stores daily surface layer states. It is assumed that a day is designated as the time of the displacement and the surface layer state. In this case, the information output unit 140 may output the surface layer state corresponding to the designated day and the displacement corresponding to the week including the day. Alternatively, when the information storage unit 150 stores the date as the time of displacement, that is, the acquisition date of the observation result used for the analysis of displacement, the information output unit 140 may output the surface layer state corresponding to the designated date and the displacement corresponding to the acquisition date of the observation result closest to the designated date. In this manner, the information output unit 140 may output the corresponding displacement and surface layer state based on a predetermined rule.

The update cycle of the displacement may be different from the update cycle of the surface layer state. Therefore, for example, when the update cycle of the displacement is longer than the update cycle of the surface layer state, the information processing system 13 can acquire a plurality of pieces of sensor information between the acquisition of one displacement to the acquisition of the next displacement. In this case, the information output unit 140 may output the surface layer states at a plurality of times based on the sensor information at a plurality of times with respect to the displacement at one time. Alternatively, when the update period of at least a part of the sensor information is longer than the update period of the displacement, the information output unit 140 may output the displacements at a plurality of times with respect to the surface layer state at one time. As described above, the information output unit 140 may output different numbers of displacements and surface layer states as the number of times of output.

### Hardware Configuration

Next, a hardware configuration of the information processing systems 10 and 13 will be described using the information processing system 10. Each component of the information processing system 10 may be a hardware circuit. Alternatively, in the information processing system 10, each component may be configured using a plurality of devices connected to each other through a network. For example, the information processing system 10 may be configured using cloud computing. Alternatively, in the information processing system 10, the plurality of components may be configured by one piece of hardware.

The information processing system 10 may be implemented as a computer device including a central processing unit (CPU), a read-only memory (ROM), and a random access memory (RAM). In addition to the above configuration, the information processing system 10 may be implemented as a computer device including another configuration such as a network interface card (NIC).

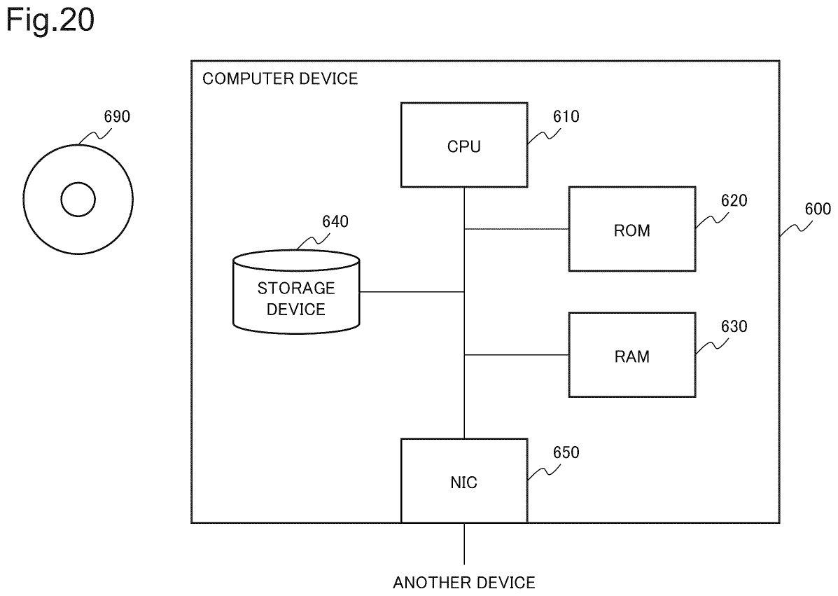

FIG. 20 is a block diagram illustrating an example of a hardware configuration of a computer device 600 forming the information processing system 10. The computer device 600 includes a CPU 610, a ROM 620, a RAM 630, a storage device 640, and an NIC 650. The CPU 610 reads a program from at least one of the ROM 620 and the storage device 640. Then, the CPU 610 controls the RAM 630, the storage device 640, and the NIC 650 based on the read program. Then, the computer device 600 including the CPU 610 controls these components to implement functions as a displacement acquisition unit 110, a sensor information acquisition unit 120, a state determination unit 130, and an information output unit 140 of the information processing system 10.

When implementing each function, the CPU 610 may use at least one of the RAM 630 and the storage device 640 as a temporary storage medium of a program and data. The CPU 610 may read the program included in the recording medium 690 storing the program in a computer readable manner using a recording medium reading device (not illustrated). Alternatively, the CPU 610 may acquire a program from another device (not illustrated) through the NIC 650, store the acquired program in at least one of the RAM 630 and the storage device 640, and operate based on the stored program.

The ROM 620 stores programs executed by the CPU 610 and fixed data. The ROM 620 is, for example, a programmable ROM (Programmable ROM (P-ROM)) or a flash ROM. The RAM 630 temporarily stores at least one of a program executed by the CPU 610 and data. The RAM 630 is, for example, a dynamic RAM (Dynamic-RAM (D-RAM)). The storage device 640 stores data and programs to be stored for a long time by the computer device 600. The storage device 640 may operate as a temporary storage device of the CPU 610. The storage device 640 may operate as the information storage unit 150. The storage device 640 is, for example, a hard disk device, a magneto-optical disk device, a solid state drive (SSD), or a disk array device.

The ROM 620 and the storage device 640 are non-volatile (non-transitory) recording media. On the other hand, the RAM 630 is a volatile (transitory) recording medium. The CPU 610 can operate based on a program stored in at least one of the ROM 620, the storage device 640, and the RAM 630. That is, the CPU 610 can operate using at least one of a nonvolatile recording medium and a volatile recording medium.

The NIC 650 relays exchange of data with another apparatus (not illustrated) through a network. The NIC 650 is, for example, a local area network (LAN) card. The NIC 650 is not limited to wired communication, and may be wireless communication. In the computer device 600 configured as described above, the CPU 610 implements a function similar to that of the information processing system 10 or 13 based on the program.

### Specific Example of Information Providing System

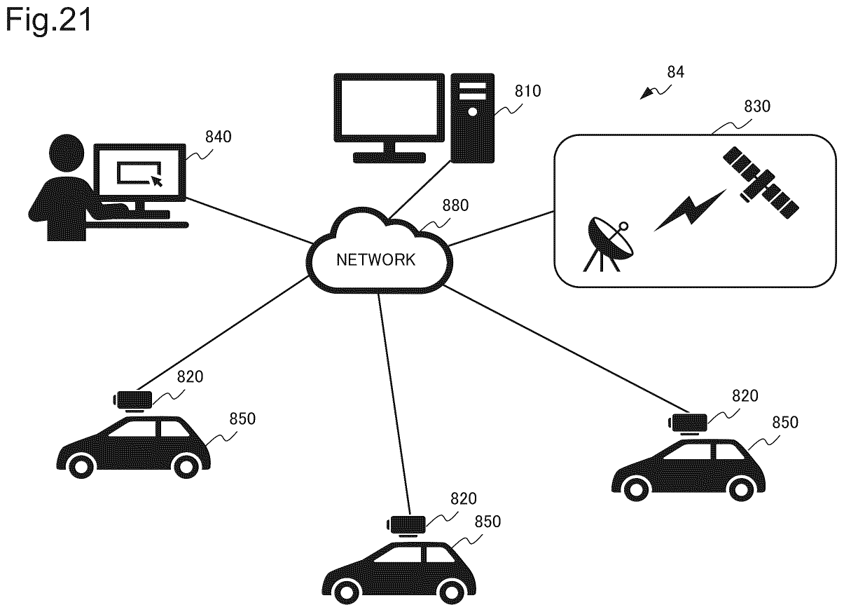

FIG. 21 is a conceptual diagram illustrating an information providing system 84 which is a specific example of the information providing systems 80 and 83. In the information providing system 84, the subject of each configuration may be the same or different. In FIG. 21, a computer device 810 is an example of the information processing system 10. The dashcam 820 is an example of the sensor information acquisition device 20. A SAR system 830 including an artificial satellite equipped with the SAR and a ground station is an example of the ground observation system 30. A terminal device 840 is an example of the display device 40. A vehicle 850 is an example of a moving object that moves with the dashcam 820 mounted thereon. In FIG. 21, in order to facilitate understanding, the dashcam 820 is mounted outside the vehicle 850. However, the dashcam 820 may be mounted inside the vehicle 850.

The network 880 is a communication path that connects each device and each system to each other. For example, the network 880 may be the Internet, a public telephone line, a dedicated communication network, or a combination thereof. However, the network 880 is not limited to the above, and may be any communication path as long as the communication path can connect each device and each system to each other. The network 880 may be configured using a plurality of networks instead of one network. For example, as described below, the network 880 may be configured using different networks as networks used for connection between the computer device 810 and another device or system.
Connection between computer device 810 and dashcam 820,
Connection between computer device 810 and SAR system 830,
Connection between computer device 810 and terminal device 840.

Alternatively, when there are a plurality of dashcams 820, the network 880 may be configured using a plurality of networks corresponding to the location of the dashcam 820 as connections between the computer device 810 and the dashcam 820.

As described above, the number of components included in FIG. 21 is an example, and is not limited to the number illustrated in FIG. 21. For example, one, two, or four or more dashcams 820 may be provided. The components illustrated in FIG. 21 can be replaced with other devices or systems. For example, at least some of the dashcams 820 may be mounted on a moving object different from the vehicle 850, such as a drone. Alternatively, the dashcam 820 may be replaced with a fixed camera.

The vehicle 850 travels on a structure, such as a road or a bridge, with the dashcam 820 mounted thereon. The vehicle 850 may travel in a structure, such as a tunnel. The dashcam 820 acquires sensor information of a structure, such as a road or a bridge on which the vehicle 850 travels, and outputs the acquired sensor information to the computer device 810. For example, the dashcam 820 acquires an image and acceleration as sensor information, and outputs the image and acceleration to the computer device 810. The SAR system 830 outputs an observation result of the ground to the computer device 810. Alternatively, the SAR system 830 analyzes the observations and outputs the displacement of the ground including the structures.

The computer device 810 acquires the sensor information from the dashcam 820 and determines the surface layer state of the structure based on the acquired sensor information. The computer device 810 acquires observation results from the SAR system 830, and analyzes the acquired observation results to acquire the displacement of the structure. Alternatively, the computer device 810 acquires the displacement of the structure from the SAR system 830. That is, the computer device 810 acquires the displacement of the structure that is the result of the analysis using the observation result acquired by the SAR system 830. Then, the computer device 810 outputs the displacement and the surface layer state of the entire or partial region of the structure to the terminal device 840. The terminal device 840 displays the displacement and the surface layer state of the entire or partial region of the structure acquired from the computer device 810.

As the computer device 810, the dashcam 820, the SAR system 830, the terminal device 840, and the vehicle 850, generally available products and systems can be applied. For example, a general personal computer may be used as the computer device 810. As described above, the devices and systems used as the computer device 810, the dashcam 820, the SAR system 830, the terminal device 840, and the vehicle 850 are not particularly limited.

Some or all of the above example embodiments may be described as in the following Supplementary Notes, but are not limited to the following description.

### Supplementary Note 1

An information processing system, including:

a displacement acquisition means for acquiring a displacement of a structure on a ground;

a sensor information acquisition means for acquiring sensor information related to a surface of the structure;

a state determination means for determining a surface layer state of the structure based on the sensor information; and

an information output means for outputting the displacement in an entire or partial region of the structure and the surface layer state in the entire or partial region of the structure.

### Supplementary Note 2

The information processing system according to Supplementary Note 1, in which

the information output means outputs the displacement and the surface layer state in a linear region as the displacement and the surface layer state in a partial region of the structure.

### Supplementary Note 3

The information processing system according to Supplementary Note 1 or 2, including:

an information storage means for storing at least one of the displacement at a plurality of times and the surface layer state at a plurality of times,

in which the information output means outputs at least one of the displacement and the surface layer state at a plurality of times.

### Supplementary Note 4

The information processing system according to any one of Supplementary Notes 1 to 3, in which

the information output means outputs the displacement and the surface layer state corresponding to a designated time.

### Supplementary Note 5

The information processing system according to Supplementary Note 4, in which

the information output means outputs the displacement and the surface layer state according to a change in time when the designated time changes.

### Supplementary Note 6

The information processing system according to any one of Supplementary Notes 3 to 5, in which

the information output means outputs the displacement exceeding a threshold value at the designated time and the corresponding surface layer state.

### Supplementary Note 7

The information processing system according to any one of Supplementary Notes 1 to 6, in which

the information output means outputs the displacement and the surface layer state in a section obtained by dividing the structure into a plurality of sections.

### Supplementary Note 8

The information processing system according to Supplementary Note 7, in which

the section is at least one of a unit of management of the structure, a unit of determination of a state of the structure, a unit of repair of the structure, and a combination thereof.

### Supplementary Note 9

The information processing system according to any one of Supplementary Notes 1 to 8, in which

the sensor information acquisition means acquires the sensor information acquired by a sensor information acquisition device mounted on a moving object.

### Supplementary Note 10

The information processing system according to Supplementary Note 9, in which

the moving object is a vehicle,

the sensor information acquisition device is a dashcam, and

the sensor information is an image of a surface of the structure.

### Supplementary Note 11

The information processing system according to any one of Supplementary Notes 1 to 10, in which

the displacement acquisition means acquires the displacement of the structure based on an observation result of a ground observation system including a synthetic aperture radar that observes the ground including the structure.

### Supplementary Note 12

An information processing method, including:

acquiring a displacement of a structure on a ground;

acquiring sensor information related to a surface of the structure;

determining a surface layer state of the structure based on the sensor information; and

outputting the displacement in an entire or partial region of the structure and the surface layer state in the entire or partial region of the structure.

### Supplementary Note 13

A recording medium that records a program for causing a computer to execute:

processing for acquiring a displacement of a structure on a ground;

processing for acquiring sensor information related to a surface of the structure;

processing for determining a surface layer state of the structure based on the sensor information; and

processing for outputting the displacement in an entire or partial region of the structure and the surface layer state in the entire or partial region of the structure.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

### REFERENCE SIGNS LIST

10 information processing system
13 information processing system
20 sensor information acquisition device
30 ground observation system
40 display device
80 information providing system
83 information providing system
84 information providing system
110 displacement acquisition unit
120 sensor information acquisition unit
130 state determination unit
140 information output unit
150 information storage unit
600 computer device
610 CPU
620 ROM
630 RAM
640 storage device
650 NIC
810 computer device
820 dashcam
830 SAR system
840 terminal device
850 vehicle
880 network

What is claimed is:

1. An information processing system, comprising:
a memory configured to store instructions; and
one or more processors configured to execute the instructions to:
acquire a displacement of a structure on a ground;
acquire sensor information related to a surface of the structure;
determine a surface layer state of the structure based on the sensor information; and
output the displacement in an entire or partial region of the structure and the surface layer state in the entire or partial region of the structure.

2. The information processing system according to claim 1, wherein
the one or more processors are further configured to execute the instructions to:
output the displacement and the surface layer state in a linear region as the displacement and the surface layer state in a partial region of the structure.

3. The information processing system according to claim 1, comprising:
the one or more processors are further configured to execute the instructions to:
store at least one of the displacement at a plurality of times and the surface layer state at a plurality of times; and
output at least one of the displacement and the surface layer state at a plurality of times.

4. The information processing system according to claim 1, wherein
the one or more processors are further configured to execute the instructions to:
output the displacement and the surface layer state corresponding to a designated time.

5. The information processing system according to claim 4, wherein
the one or more processors are further configured to execute the instructions to:
output the displacement and the surface layer state according to a change in time when the designated time changes.

6. The information processing system according to claim 3, wherein
the one or more processors are further configured to execute the instructions to:
output the displacement exceeding a threshold value at the designated time and the corresponding surface layer state.

7. The information processing system according to claim 1, wherein
the one or more processors are further configured to execute the instructions to:
output the displacement and the surface layer state in a section obtained by dividing the structure into a plurality of sections.

8. The information processing system according to claim 7, wherein
the section is at least one of a unit of management of the structure, a unit of determination of a state of the structure, a unit of repair of the structure, and a combination thereof.

9. The information processing system according to claim 1, wherein
the one or more processors are further configured to execute the instructions to:
acquire the sensor information acquired by a sensor information acquisition device mounted on a moving object.

10. The information processing system according to claim 9, wherein
the moving object is a vehicle,
the sensor information acquisition device is a dashcam, and
the sensor information is an image of a surface of the structure.

11. The information processing system according to claim 1, wherein
the one or more processors are further configured to execute the instructions to:
acquire the displacement of the structure based on an observation result of a ground observation system including a synthetic aperture radar that observes the ground including the structure.

12. An information processing method, comprising:
acquiring a displacement of a structure on a ground;
acquiring sensor information related to a surface of the structure;
determining a surface layer state of the structure based on the sensor information; and
outputting the displacement in an entire or partial region of the structure and the surface layer state in the entire or partial region of the structure.

13. A non-transitory computer-readable recording medium that records a program for causing a computer to execute:
acquiring a displacement of a structure on a ground;
acquiring sensor information related to a surface of the structure;
determining a surface layer state of the structure based on the sensor information; and
outputting the displacement in an entire or partial region of the structure and the surface layer state in the entire or partial region of the structure.
